(19) United States
(12) Patent Application Publication
(10) Pub. No.: US 2009/0116920 A1
(43) Pub. Date: May 7, 2009

(54) Rotary Cutting Tool

(75) Inventor: Byung Gyun Bae, Taegu (KR)

Correspondence Address: HOLME ROBERTS & OWEN LLP, 1700 LINCOLN STREET, SUITE 4100, DENVER, CO, 80203, US

(73) Assignee: TaeguTec Ltd., Taegu (KR)

(21) Appl. No.: 12/107,035

(22) Filed: Apr. 21, 2008

Related U.S. Application Data
(63) Continuation of application No. PCT/KR2007/005549, filed on Nov. 5, 2007.

(51) Int. Cl. B23B 51/00

(52) U.S. Cl. 408/227

(57) ABSTRACT

The present invention discloses a rotary cutting tool which can maintain a secure coupling state between the shank and the cutting head and enhance the durability of the shank by preventing a damage of the shank and the cutting head from being generated. In the rotary cutting tool according to the present invention, the cutting head comprises a central post in a cylindrical shape which is concentric with the rotating axis of the drill body and a plurality of wings formed at the upper end of the central post extending in the radial direction, each of the wings has an end surface, an upper surface, a lower surface, a forward surface which is facing the drill rotational direction, and a rearward surface opposite to the forward surface, the forward surface being provided with the chip flute extended over to the lateral wall of the central post, the lateral wall of the central post consisting of cutouts forming the chip flutes and the circular outer circumferential surfaces, the circular outer circumferential surface of the central post being provided with rotation guide element thereon extending in a circumferential direction. The coupling structural means comprises a plurality of coupling limbs extending from the circumferential portion of the tool shank in parallel with the rotating axis to provide a central opening therebetween for receiving the central post, each of the coupling limbs consisting of a torque bearing part in the upper portion and a frictional fastening part in the lower portion, the torque bearing part being provided on the side of the drill rotational direction with a recess delimited by an axial bearing surface and a torque bearing surface for resting one of the wings therein, the inner wall of the frictional fastening part having a transversal cross section of a circular arc such that the inner wall of the frictional fastening part has a surface contact with the circular outer circumferential surface of the central post, the inner walls of the frictional fastening parts being provided with coupling elements engageable with rotation guide elements of the central post.

### CROSS-REFERENCE TO RELATED APPLICATIONS

This application is a continuation of PCT International Application No. PCT/KR2007/005549, filed Nov. 5, 2007 and entitled “ROTARY CUTTING TOOL,” which is incorporated herein by reference in its entirety.

### BACKGROUND OF THE INVENTION

1. The Field of the Invention

The present invention relates to a rotary cutting tool. More particularly, the present invention relates to a rotary cutting tool capable of providing an increased clamping force and durability by a direct surface-contact between a cutting head and a tool shank.

2. The Relevant Technology

A drilling tool comprising an exchangeable cutting head is disclosed in Publication WO2003/070408. FIG. 1 is a perspective view of a cutting head constituting the above-mentioned drilling tool in Publication WO2003/070408 and FIG. 2 is a perspective view of a corresponding shank. In FIG. 1, a cutting head 10 includes a fastening pin 13 and two wings 11, 12 formed at an upper side of the fastening pin 11. Bearing surfaces 11a, 12a are formed on sides of the wings 11, 12, the bearing surfaces being contacted with bearing surfaces 21a, 22a of a shank 20 described later.

The shank 20 includes two limbs 21, 22. Chucking grooves 31, 32 are defined by the limbs 21, 22. In addition, a space 30 is formed between the limbs 21, 22 for receiving the fastening pin 13 of the cutting head 10.

Recesses 21c, 22c are defined by bottom surfaces 21b, 22b and the bearing surfaces 21a, 22a are formed on sides of upper portions of the limbs 21, 22 so that the wings 11, 12 of the cutting head 10 are received in the recesses 21c, 22c, respectively.

In a state where the cutting head 10 and the shank 20 are coupled with each other, the wings 11, 12 of the cutting head 10 are located in the recesses 21c, 22c. The bearing surface 11a, 12a of the wings 11, 12 are contacted with the bearing surfaces 21a, 22a of the recesses 21a, 22c and lower surfaces are placed on the bottom surfaces 21b, 22b of the recesses 21c, 22c.

Further, in the state where the cutting head 10 and the shank 20 are coupled with each other, the fastening pin 13 of the cutting head 10 is inserted in the space 30 of the shank 20 such that an outer circumference surface of the fastening pin 13 is in line contact with the inner circumference surfaces of the limbs 21, 22 forming the space 30.

FIG. 3 is a perspective view of the drilling tool and shows a state where the cutting head 10 and the shank 20 shown in FIG. 1 and FIG. 2 are coupled with each other.

A relation among the fastening pin 13 of the cutting head 10 and the limbs 21, 22 of the shank 20 is described below with reference to FIG. 1, FIG. 2, FIG. 4 and FIG. 5.

FIG. 4 is a sectional view showing a relation between the limbs 21, 22 of the shank 20 and the fastening pin 13 of the cutting head 10 before they are fastened by rotating the cutting head 10 in the shank 20. FIG. 5 is a sectional view showing a relation a relation between the limbs 21, 22 of the shank 20 and the fastening pin 13 of the cutting head 10 in a fastened state after rotating the cutting head 10 in the shank 20.

When the cutting head 10 is placed in the shank 20 for coupling the cutting head 10 with the shank 20, the wings 11, 12 of the cutting head 10 are not yet received in the recesses 21c, 22c of the shank 20, but correspond to the chucking grooves 31, 32, each of which being formed between the limbs 21, 22. In addition, curved outer circumferential surfaces 13a of the fastening pin 13 of the cutting head 10 correspond to the chucking grooves 31, 32 (state of FIG. 4).

Here, the contour of the curved outer circumferential surfaces 13a is in a shape of ellipse with the major axis disposed in the chucking groove for easy initial placement.

Then, once the cutting head 10 is rotated in the arrow direction of FIG. 4, the wings 11, 12 of the cutting head 10 are received in the recesses 21c, 22c of the shank 20. At this time, the bearing surfaces 11a, 12a of the wings 11, 12 are contacted with the bearing surfaces 21a, 22a of the recesses 21c, 22c, respectively, and the lower surfaces thereof are placed on the bottom surfaces 21b, 22b of the recesses 21c, 22c.

Simultaneously, the elliptic outer circumferential surfaces 13a of the fastening pin 13 of the cutting head 10 are elastically contacted with the inner circumference surfaces of the limbs 21, 22b of the shank 20 (a state of FIG. 5). Accordingly, the fastening pin 13 of the cutting head 10 is securely coupled with the limbs 21 and 22 of the shank 20, and a rotational force of the shank 20 is transmitted to the cutting head 10 due to the above coupling structure.

However, in a process for coupling the cutting head 10 with shank 20, the below problems are generated.

As shown in FIG. 4, an outer circumference surface of the fastening pin 13 of the cutting head 10 has the elliptic outer circumferential surfaces 13a and cutout portions 13b, each cutout portion being placed between the elliptic outer circumferential surfaces. Prior to rotating the cutting head 10, each border portion between the elliptic outer circumferential surface 13a and the cutout portion 13b is contacted with an inner surface of each of the limbs 21, 22.

During insertion and rotation of the fastening pin 13 of the cutting head 10, the sharp border portion between the elliptic outer circumferential surface 13a and the cutout portion 13b makes scratches on the inner surface of each of the limbs 21, 22 of the shank 20.

Further, as the drilling process is performed, a cutting edge of the cutting head 10 is worn away to the point that the abraded cutting head should be replaced with a new one. As the cutting head 10 is repeatedly coupled with the shank 20, the sharp border portions formed on the fastening pin 13 of the cutting head 10 are repeatedly contacted with inner surfaces of the limbs 21, 22 of the shank 20 so that a depth of the scratch and the scratch area are gradually increased. The above scratch formed on the shank 20 reduces a coupling force between the cutting head 10 and the shank 20 and causes a reduction of the expected life span of the expensive shank 20.

As shown in FIG. 4 and FIG. 5, the fastening pin 13 of the cutting head 10 has an elliptical shape in section in which the line connecting centers of the curved outer circumferential surfaces 13a is the major axis. Accordingly, the curved outer circumferential surfaces 13a of the fastening pin 13 are in line contact with the limbs 21, 22 of the shank 20 along the longitudinal direction (In the sectional view of FIG. 5, contacts appear to be made at points). Such contact between the fastening pin 13 and each limb is susceptible to wearing and reduces the coupling force between the cutting head 10 and the shank 20.

In addition, in the structure of the cutting head 10 shown in FIG. 1, an axial directional pressure and a rotational torque of the shank 20 are transmitted to the inclined bearing surfaces 11a, 11b of the wings 11, 12 so that a fatigue load of each of the wings 11, 12 of the cutting head 10 is increased. In addition, there is no locking structure against axial movement; the cutting head 10 is only unstably fastened along the axial direction.

### BRIEF SUMMARY OF THE INVENTION

The present invention is conceived to solve the above problems of the conventional rotary cutting tool. The present invention thus provides a rotary cutting tool that can maintain a secure coupling state between the shank and the cutting head and enhance the durability of the shank by preventing damage of the shank and the cutting head from being generated.

In one example of a rotary cutting tool according to the present invention, the cutting head includes a central post in a cylindrical shape that is concentric with the rotating axis of the drill body and a plurality of wings formed at the upper end of the central post extending in the radial direction. Each of the wings has an end surface, an upper surface, a lower surface, a forward surface which is facing the drill rotational direction, and a rearward surface opposite to the forward surface. The forward surface is provided with the chip flute extended over to the lateral wall of the central post, the lateral wall of the central post consisting of cutouts forming the chip flutes and the circular outer circumferential surfaces. The circular outer circumferential surface of the central post is provided with a rotation guide element thereon extending in a circumferential direction.

The coupling structural means includes a plurality of coupling limbs extending from the circumferential portion of the tool shank in parallel with the rotating axis to provide a central opening therebetween for receiving the central post. Each of the coupling limbs has a torque bearing part in the upper portion and a frictional fastening part in the lower portion, the torque bearing part being provided on the side of the drill rotational direction with a recess delimited by an axial bearing surface and a torque bearing surface for resting one of the wings therein. The inner wall of the frictional fastening part has a transversal cross section of a circular arc such that the inner wall of the frictional fastening part has a surface contact with the circular outer circumferential surface of the central post, the inner walls of the frictional fastening parts being provided with coupling elements engageable with rotation guide elements of the central post.

The surface contact is made by forcing the central post with the rotation guide elements disposed to guide the coupling element in the central opening to rotate in the reverse drill rotational direction until the rearward surfaces of the wings contact the torque bearing surfaces so that the inner walls of the frictional fastening parts are elastically pressed onto the circular outer circumferential surface of the central post.

In the rotary cutting tool of the present invention, the rotation guide elements may be rotation guide grooves and the coupling elements may be protruded guide ribs.

In addition, the central post may have chamfered portion formed on sides of the outer circumferential surfaces thereof, the chamfered portion being facing the reverse drill rotational direction. Alternatively, the frictional fastening part may have chamfered portions formed on sides of the inner walls which is facing the reverse drill rotational direction.

Here, it is preferable that the torque bearing surfaces of the coupling limbs are parallel to the axial direction and the radial elastic displacement of the coupling limbs is proportionally increased toward the upper portion.

The rotary cutting tool according to the present invention as described herein has several example advantages as follows.

When the drilling process is performed, due to the above configuration, an axial directional stress applied through the cutting head is transmitted to the axial bearing surfaces and a rotational torque is transmitted to the upright torque bearing surfaces. Accordingly, the frictional force is not excessively applied to the contact surfaces between the tool shank and the central post.

In addition, the circular outer circumference surfaces of the central post are in surface contact with the inner walls of the coupling limbs so that a friction surface is increased. Accordingly, the abrasion of the central post and the coupling limbs can be minimized and the total coupling force between two members can be increased.

Further, the circular outer circumference surfaces of the central post of the cutting head can be contacted with the inner walls of the coupling limbs of the tool shank without a generation of large resistance therebetween. Accordingly, the scratches and shaving are not generated on the inner walls of the coupling limbs of the tool shank, and so it is possible to lengthen the expected life of the expensive tool shank.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a cutting head constituting a conventional drilling tool;

FIG. 2 is a perspective view of a shank constituting a conventional drilling tool;

FIG. 3 is a perspective view showing a state where the cutting head and the shank shown in FIG. 1 and FIG. 2 are coupled with other;

FIG. 4 is a sectional view showing a relation among limbs of the shank and a fastening pin of the cutting head before rotating the cutting head shown in FIG. 1 in the shank shown FIG. 2;

FIG. 5 is a sectional view showing a relation among the limbs of the shank and a fastening pin of the cutting head after rotating the cutting head shown in FIG. 1 in the shank shown in FIG. 2;

FIG. 6 is a perspective view of a cutting head constituting a drilling tool according to the present invention;

FIG. 7 is an exploded perspective view of the drilling tool according to the present invention having the cutting head and a shank;

FIG. 8 is a plane view of the shank shown in FIG. 7;

FIG. 9 is a sectional view taken along the line A-A in FIG. 7 and showing a relation between a central post of the cutting head and coupling limbs of the tool shank before rotating the cutting head in a central space of the central shank;

FIG. 10 is a sectional view taken along the line A-A in FIG. 7 and showing a relation between a central post of the cutting head and a coupling limb of the tool shank after rotating the cutting head in the central space of the tool shank; and

FIG. 11 is a sectional view showing a state where the cutting head is coupled with the tool shank.

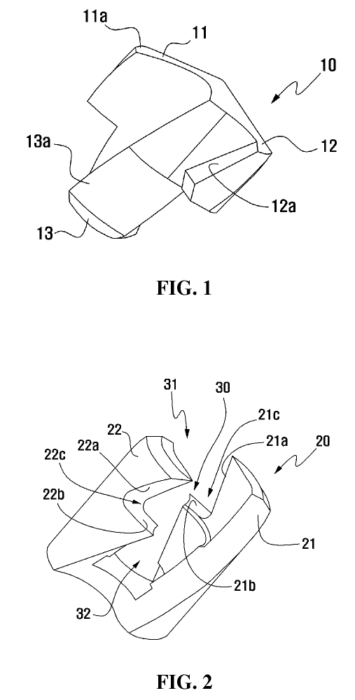

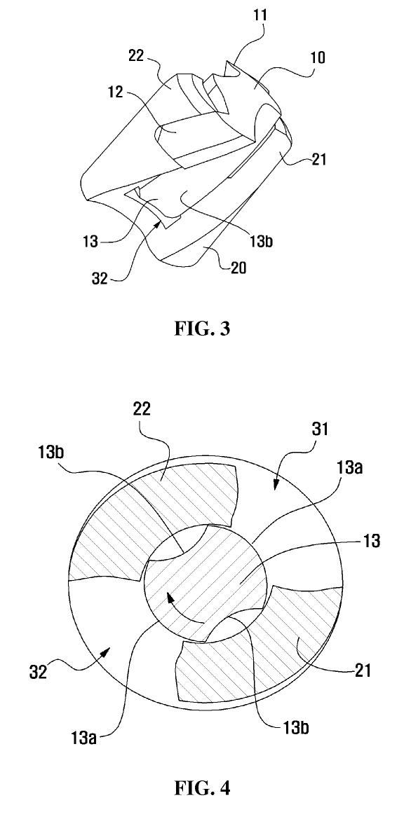

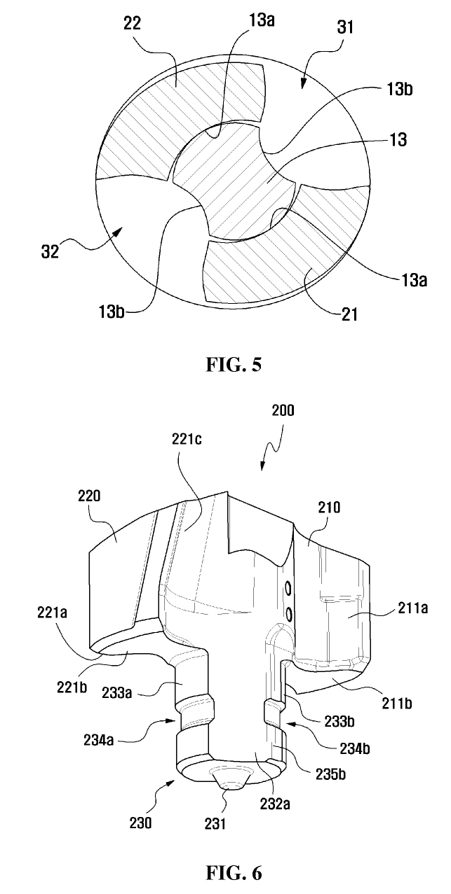

### DETAILED DESCRIPTION OF THE PREFERRED EMBODIMENTS

Hereinafter, a rotary cutting tool according to the present invention is described in detail with reference to the accompanying drawings. As one example of the rotary cutting tool, a drilling tool utilized in a drilling process will be illustrated.

In the following description, numerous specific details are set forth in order to provide a thorough understanding of the present invention. It will be obvious, however, to one skilled in the art that the present invention may be practiced without these specific details. In other instances, well-known aspects of rotary cutting tools have not been described in particular detail in order to avoid unnecessarily obscuring the present invention.

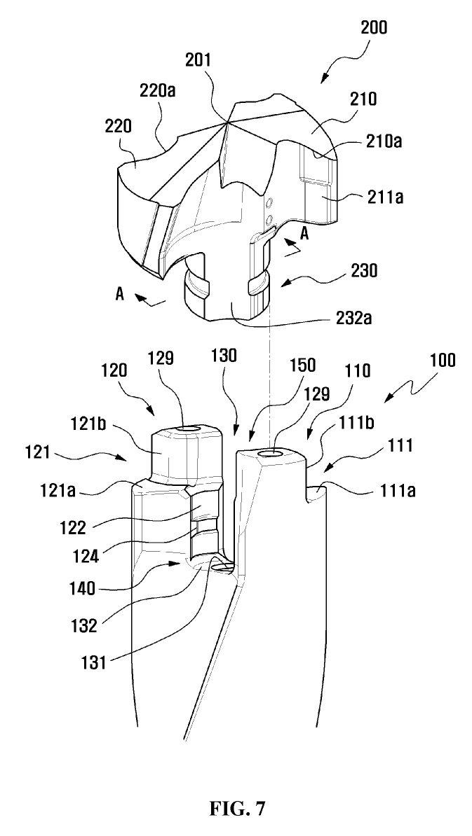

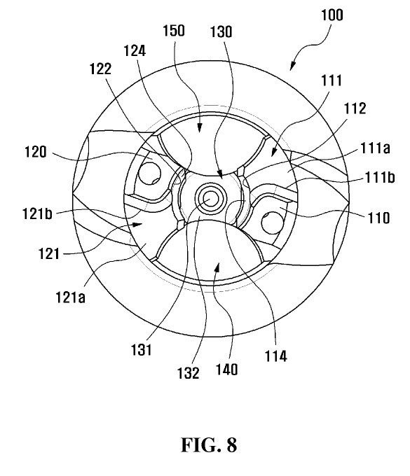

Accordingly, FIG. 6 is a perspective view of a cutting head constituting a drilling tool according to the present invention, FIG. 7 is an exploded perspective view of the drilling tool according to the present invention having the cutting head and a shank, and FIG. 8 is a plane view of the shank shown in FIG. 7.

A rotary cutting tool according to one embodiment of the present invention includes a cutting head 200 and a tool shank 100. The tool shank 200 is formed integrally with a drill body having an elongate cylindrical shape with chip flutes provided on the lateral surface thereof. Also, the cutting head 200 is replaceably mounted to a coupling structural means provided at an upper end portion of the tool shank 100.

The cutting head 200 includes a central post 230 in a cylindrical shape which is concentric with a rotating axis of the drill body and a plurality of wings 210, 220 formed at the upper end of the central post 230 and extending in the radial direction.

Each of the wings 210, 220 has an end surface, an upper surface, a lower surface 211b, 221b, a forward surface 221c which is facing the drill rotational direction, and a rearward surface 211a, 221a opposite to the forward surface. The forward surface 221c is provided with a chip flute extended over to the lateral wall of the central post 230.

The lateral wall of the central post 230 has cutouts 232a, forming the chip flutes, and circular outer circumferential surfaces, 233a, 233b, each of the circumferential surfaces 233a, 233b being located between the cutouts. The circular outer circumferential surface 233a, 233b of the central post 230 is provided with rotation guide elements 234a, 234b formed thereon and extending in a circumferential direction. Here, the rotation guide elements 234a, 234b are a groove having a certain depth.

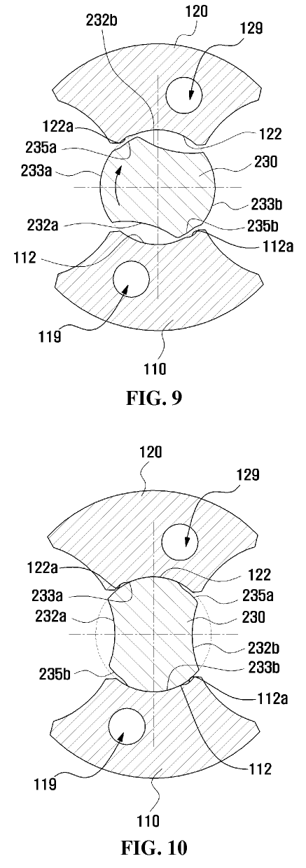

In addition, chamfered portions 235a, 235b are formed on outer end portions of the circular outer circumferential surfaces 233a, 233b corresponding to the rear surfaces 211a, 221a. The chamfered portions 235a, 235b can have various shapes. For example, as shown in FIG. 6 and FIG. 9, an end portion of the circular outer circumferential surface 233a, 233b corresponding to the rear surface 211a, 221a is grinded such that the end portion of the circular outer circumferential surface 233a, 233b is inclined downward toward the cutout 232a, 232b and subsequently being a partial circular arc with a smaller diameter to form the chamfered portion 235a, 235b.

The coupling structural means formed on the tool shank 100 includes a plurality of coupling limbs 110, 120 extending from the circumferential portion of the tool shank 100 in parallel with the rotating axis and a central opening 130 defined by the coupling limbs 110, 120 for receiving the central post 230 of the cutting head 200,

Each of the coupling limbs 110, 120 has a torque bearing part formed in the upper portion and a frictional fastening part formed in the lower portion thereof.

The torque bearing part is provided on the side of the drill rotational direction and has a recess 111, 121 delimited by an axial bearing surface 111a, 121a and a torque bearing surface 111b, 121b for resting one of the wings 210, 220 of the cutting head 200 therein.

Inner walls of the coupling limbs 110, 120 act as the frictional fastening part. The inner walls of the coupling limbs 110, 120 have a transversal cross section of a circular arc such that the inner walls of the coupling limbs 110, 120 are in surface contact with the circular outer circumferential surface of the central post 230. In addition, the inner walls of the coupling limbs 110, 120 are provided with coupling elements 114, 124 engageable with the rotation guide elements 234a, 234b of the central post 230 of the cutting head 200.

The rotation guide elements 234a, 234b of the cutting head 200 are rotation guide grooves formed on the circular outer circumferential surfaces 233a, 233b of the central post 230 and extending in the circumferential direction, and the coupling elements 114, 124 of the tool shank 100 are guide ribs 114, 124 which are formed protrudent and can be received in the rotation guide grooves 243a, 234b.

A process for coupling the cutting head 200 and the tool shank 100 constituted as described above is illustrated with reference to the drawings. FIG. 9 is a sectional view taken along the line A-A and showing a relation between the central post 230 of the cutting head 200 and the coupling limbs 110, 120 of the tool shank 100 before rotating for fastening the cutting head 200 in the tool shank 200. FIG. 10 is another sectional view taken along the line A-A; FIG. 10 showing a relation among the central post 230 of the cutting head 200 and the coupling limbs 110, 120 of the tool shank 100 after rotating for fastening the cutting head 200 in the tool shank 200.

In the process, the central post 230 of the cutting head 200 is first placed in the central opening 130 of the tool shank 100. At this time, the circular outer circumferential surfaces 233a, 233b of the central post 230 are disposed to correspond to spaces 130, 140, each of spaces 130, 140 being formed between the coupling limbs 110, 120 of the shank 100 ( a state of FIG. 9).

In the state of FIG. 9, once the cutting head 200 is rotated in the arrow direction of FIG. 9 (which is opposite to the drill rotation direction) in a press fit manner, the rear surfaces 211a, 221a of the wings 210, 220 of the cutting head 200 are contacted with the torque bearing surfaces 111b, 121b constituting the recesses 111, 121 of the coupling limbs 110, 120 of the tool shank 120, and the lower surface 211b, 221b of the wings 210, 220 are contacted with the axial bearing surfaces 111a, 121a of the coupling limbs 110, 120.

Here, the inner diameter of the cylinder corresponding to the central opening 130 before the press fit rotation is formed slightly smaller than the outer diameter of the circular surface of the central post 130.

Therefore, the inner walls 112, 122 of the coupling limbs 110, 120 acting as the frictional fastening part pressurize elastically the outer surface of the central post 230 of the cutting head 200, and so the cutting head 200 is securely coupled with the tool shank 100 (a state of FIG. 10).

Further functions of the structural elements constituting the cutting head 200 and the tool shank 100 coupled with each other through the above process is illustrated below.

As shown in FIG. 7, it is preferable that the torque bearing surfaces 111b, 121b formed on the coupling limbs 110, 120 of the tool shank 110 are formed in parallel with an axial direction of the drill body and the axial bearing surfaces 111a, 121a is perpendicular to the axial direction. When the drilling process is performed, due to the above configuration an axial directional stress applied through the cutting head 200 is transmitted to the axial bearing surfaces 111a, 121a and a rotational torque is transmitted to the torque bearing surfaces 111b, 121b. Accordingly, the frictional force is not excessively applied to the contact surface between the tool shank 100 and the cutting head 200.

As shown in FIG. 9, the imaginary circle (represented by a dotted line) formed by the circular outer circumference surfaces 233a, 233b of the central post 230 of the cutting head 210 and the imaginary circle formed by the inner walls 112, 122 of the coupling limbs 110, 120 of the tool shank 100 have the substantially same curvature of radius.

In this structure, since the circular outer circumference surfaces 233a, 233b of the central post 230 are in surface contact with the inner walls 112, 122 of the coupling limbs 110, 120, friction surface is increased and clamping force is so increased for a given contact pressure. Accordingly, for a same design clamping force, the abrasion of the central post 230 and the coupling limbs 110, 120 can be minimized and durability of the tool shank 100 can be increased successfully.

On the other hand, when the cutting head 200 is rotated in the tool shank 100 from the released state shown in FIG. 9 to the fastening state shown in FIG. 10, the chamfered portions 235a, 235b formed on the end portions of the circular outer circumference surfaces 233a, 233b of the central post 230 engage with the inner walls 121, 112 of the coupling limbs 120, 121 at initiation of the rotation. Accordingly, the circular outer circumference surfaces 233a, 233b of the central post 230 of the cutting head 200 can be smoothly contacted with the inner walls 122, 121 of the coupling limbs 120, 110 of the tool shank 100 without a large resistance therebetween.

In addition, in cases where the central post 230 is repeatedly rotated in the tool shank 100 for replacing the cutting head 200 with new ones, the scratches and shaving are not generated on the inner walls 122, 121 of the coupling limbs 120, 110 of the tool shank 100 due to the above chamfered portions 235a, 235b, and so it is possible to lengthen the life time of the expensive tool shank 100.

When the cutting head 200 has a worn tip 201 and worn cutting edges 210a, 220a, it should be replaced. As a result, dismounting and mounting of the cutting head 200 with respect to the cutting shank 100 are repeatedly carried out. In theses situations, the present invention can reduce the damage to the tool shank, which is more expensive that the cutting head, to lengthen a lifetime of the tool shank.

In addition, chamfered portions 112a, 122a can be formed on drill rotation sides of the inner walls 112, 122 of the coupling limbs 110, 120, that is, areas corresponding to the chamfered portions 235a, 235b formed on the central post 230 at the initial stage of rotation of the cutting head 200. Due to the above chamfered portions 112a, 122a formed on the inner walls 112, 122 of the coupling limbs 110, 120, an initial contact between the circular outer circumferential surface 233a, 233b of the central post 230 of the cutting head 200 and the inner wall 121, 112 of the coupling limb 120, 110 of the tool shank 100 may be performed even more smoothly.

In a state of FIG. 10, the guide ribs 114, 124 formed on the inner walls 112, 122 of the coupling limbs 110, 120 of the tool shank 100 are received in the rotation guide grooves 234a, 234b formed on the central post 230 of the cutting head 200, respectively, so the cutting head 200 and the tool shank 100 are coupled with each other without a pull-out movement of the cutting tool in the axial direction of the tool body. In addition, during the rotational transiting from the released state of FIG. 9 to the fastened state of FIG. 10, a rotation of the central post 230 with respect to the tool shank 100 is performed in a guided state by the rotation guide grooves 234a, 234b and the guide ribs 114, 124 received therein.

Here, the tool shank 100 can have the rotation guide grooves formed on the inner walls 112, 122 of the coupling limbs 110, 120 thereof and the guide ribs can be formed on the central post 230 of the cutting head 200.

However, the guide ribs 114, 124 as described above provide the coupling limbs 110, 120 of the tool shank 100 with a stronger structure. In addition, due to this structure the tool shank 100 of the present invention is useful particularly to the drilling tool having a small diameter. In addition, the rotation guide grooves 234a, 234b can be easily formed on the central post 230 of the cutting head 200 with a small diameter.

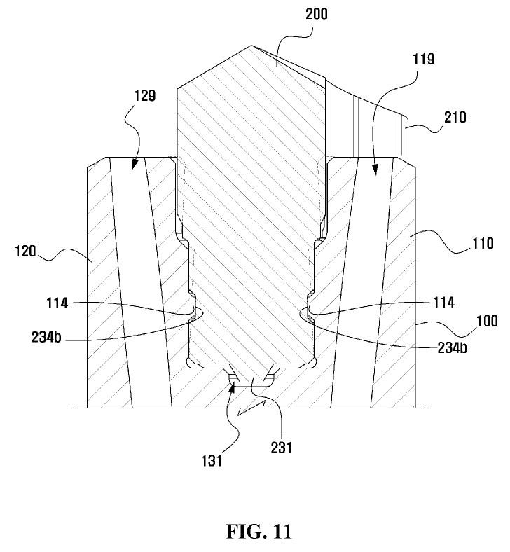

On the other hand, it is preferable that a radial elastic displacement of the coupling limbs 110, 120 of the tool shank 100 is proportionally increased toward the upper portion. That is, as indicated exaggeratedly by the dotted line in FIG. 11, in the state that the tool shank 100 and the cutting head 200 are not fastened with each other, a diameter of the imaginary circle formed by the inner walls 112, 122 of the coupling limbs 110, 120 (i.e., a distance between the inner walls 112, 122 of the coupling limbs 110, 120) is decreased toward an upper portion.

Due to the above structure, when the central post 230 of the cutting head 200 is inserted in the central opening 130 of the tool shank 100, pressure is uniformly exerted on the entire central post 230.

As shown in FIG. 6 and FIG. 7, the cutting head 200 can further include a hinge pin 231 formed at a central portion of a lower surface of the central post 230, and the tool shank 100 can further include a hole 131 formed on a central portion of a bottom surface of the central opening at the center corresponding to the hinge pin 231 of the cutting head 230.

When the cutting head 200 is coupled with the tool shank 100, a rotational movement of the cutting head 200 is guided by inserting the hinge pin 231 into the hole 131, so both members can be accurately coupled with each other.

FIG. 11 is a sectional view showing a state where the cutting head 200 is coupled with the tool shank 100 and shows that cooling fluid flow passages 119, 129 are formed in the tool shank 100. That is, the cooling fluid flow passages 119, 129 can be formed in the respective coupling limbs 110, 120 of the tool shank 100. Outlets of the cooling fluid flow passages 119, 129 are disposed on an upper surface of the coupling limbs 110, 120.

Cooling fluid supplied from an outside exterior is flowed through the cooling fluid flow passages 119, 129 and then discharged to the cutting head 200 so that cooling fluid cools the cutting head 200 and the workpiece, which is machining.

In a comparative experiment, only 30 to 40 cutting heads could be replaceably mounted to one tool shank according to the rotary cutting tool of the prior art. By using the rotary cutting tool according to the present invention, however, more than 70 cutting heads could be replaceably mounted to one tool shank.

Although the preferred embodiment has been described with reference to the preferred embodiment thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and appended claims. In addition to variations and modifications in the component parts and/or arrangements, alternative uses will also be apparent to those skilled in the art. The scope of the invention is therefore indicated by the appended claims rather than by the foregoing description. All changes which come within the meaning and range of equivalency of the claims are to be embraced within their scope.

What is claimed is:

1. A rotary cutting tool having a drill body in an elongate cylindrical shape with chip flutes provided on the lateral surface thereof, formed by replaceably fastening a cutting head with a coupling structural means provided at the upper end portion of a tool shank, wherein:
the cutting head comprises a central post in a cylindrical shape which is concentric with the rotating axis of the drill body and a plurality of wings formed at the upper end of the central post extending in the radial direction, each of the wings has an end surface, an upper surface, a lower surface, a forward surface which is facing the drill rotational direction, and a rearward surface opposite to the forward surface, the forward surface being provided with the chip flute extended over to the lateral wall of the central post, the lateral wall of the central post consisting of cutouts forming the chip flutes and the circular outer circumferential surfaces, the circular outer circumferential surface of the central post being provided with rotation guide element thereon extending in a circumferential direction;
the coupling structural means comprises a plurality of coupling limbs extending from the circumferential portion of the tool shank in parallel with the rotating axis to provide a central opening therebetween for receiving the central post, each of the coupling limbs consisting of a torque bearing part in the upper portion and a frictional fastening part in the lower portion, the torque bearing part being provided on the side of the drill rotational direction with a recess delimited by an axial bearing surface and a torque bearing surface for resting one of the wings therein, the inner wall of the frictional fastening part having a transversal cross section of a circular arc such that the inner wall of the frictional fastening part has a surface contact with the circular outer circumferential surface of the central post, the inner walls of the frictional fastening parts being provided with coupling elements engageable with rotation guide elements of the central post;
wherein the surface contact is made by forcing the central post with the rotation guide elements disposed to guide the coupling element in the central opening to rotate in the reverse drill rotational direction until the rearward surfaces of the wings contact the torque bearing surfaces so that the inner walls of the frictional fastening parts are elastically pressed onto the circular outer circumferential surface of the central post.

2. The rotary cutting tool according to claim 1, wherein the rotation guide elements are rotation guide grooves and the coupling elements are protruded guide ribs.

3. The rotary cutting tool according to claim 1, wherein the central post has a chamfered portion formed on sides of the outer circumferential surfaces thereof, the chamfered portion being oriented to face the reverse drill rotational direction.

4. The rotary cutting tool according to claim 1, wherein the frictional fastening part has chamfered portions formed on sides of the inner walls which are facing the reverse drill rotational direction.

5. The rotary cutting tool according to claim 1, wherein the central post has a hinge pin formed at a central portion of a lower surface thereof and the tool shank has a hole formed at a central portion of a bottom surface of the central opening thereof and the hole corresponding to the hinge pin.

6. The rotary cutting tool according to claim 1, wherein the torque bearing surfaces of the coupling limbs are parallel to the axial direction.

7. The rotary cutting tool according to claim 1, wherein the coupling limbs have outlets of cooling fluid flow passages disposed on an upper surface thereof.

8. The rotary cutting tool according to claim 1, wherein the radial elastic displacement of the coupling limbs is proportionally increased toward the upper portion.
